(19) United States
(12) Patent Application Publication
(10) Pub. No.: US 2026/0154364 A1
(43) Pub. Date: Jun. 4, 2026

(54) STORAGE MEDIUM, INFORMATION PROCESSING APPARATUS, AND CONTROL METHOD FOR INFORMATION PROCESSING APPARATUS

(71) Applicant: CANON KABUSHIKI KAISHA, Tokyo (JP)

(72) Inventor: MASAKI YANO, Kanagawa (JP)

(21) Appl. No.: 19/399,946

(22) Filed: Nov. 25, 2025

(30) Foreign Application Priority Data
Dec. 2, 2024 (JP) 2024-209787

(51) Int. Cl. G06F 16/957; G06F 16/955; G06F 40/109; G06F 40/143; G06F 40/166

(52) U.S. Cl. CPC G06F 16/9577; G06F 16/9566; G06F 40/109; G06F 40/143; G06F 40/166

(57) ABSTRACT

A non-transitory computer-readable storage medium storing a program of an application for causing an information processing apparatus to execute a method, the method comprising: accepting a selection of one of a plurality of output formats including an output in HTML format for outputting data of a layout obtained by the application; in a case where a two-dimensional code image indicating two-dimensional code is included in the data, generating an object in which predetermined reference information is embedded, in response to the output in the HTML format being selected, such that the object fits within a size of an area in which the two-dimensional code image arranged on the layout is located; replacing the two-dimensional code image with the object in the layout; and controlling so as to output, in the HTML format, the data representing the layout in which the two-dimensional code image has been replaced with the object.

### BACKGROUND

### Field of the Technology

The present disclosure relates to a storage medium, an information processing apparatus, and a control method for the information processing apparatus.

### Description of the Related Art

There are services that allows a user to create editing data such as a poster using a browser or an application operating on a terminal such as a personal computer or a smart device, and prints an image generated based on the editing data. In such applications, it is possible not only to print the generated image of the poster or the like on a recording medium, but also to output it in a description format such as HTML (HyperText Markup Language).

Patent Literature (Japanese Patent Laid-Open No. 2007-233848) discloses a method for converting a banner portion within a web page into either a URL or a two-dimensional code before printing the web page.

There is a need for a method that appropriately modifies an object included in editing data according to an output format, while maintaining the layout of the image corresponding to the editing data.

### SUMMARY

A storage medium according to one aspect of the present disclosure is a non-transitory computer-readable storage medium storing a program of an application for causing an information processing apparatus to execute a method, the method having: accepting a selection of one of a plurality of output formats for outputting data of a layout obtained by the application, the plurality of output formats including an output in HTML (HyperText Markup Language) format; in a case where a two-dimensional code image indicating two-dimensional code is included in the data, generating an object in which predetermined reference information is embedded, in response to the output in the HTML format being selected in the accepting, such that the object fits within a size of an area in which the two-dimensional code image arranged on the layout is located; replacing the two-dimensional code image with the object in the layout; and controlling so as to output, in the HTML format, the data representing the layout in which the two-dimensional code image has been replaced with the object by the replacing.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing an example of the configuration of a system;

FIG. 2 is a block diagram showing an example of the hardware configuration of an information processing apparatus;

FIG. 3 is a diagram showing an example of the software configuration of a terminal apparatus;

FIG. 4 is a diagram showing an example of an editing screen of a poster creation application;

FIG. 5 is a diagram illustrating an example of the configuration of a two-dimensional code object;

FIG. 6 is a diagram showing an example of the editing screen with the selection menu displayed;

FIG. 7 is a diagram showing an example of output result of editing data;

FIG. 8 is a flowchart showing an example of processing executed by the poster creation application;

FIG. 9 is a flowchart showing an example of replacement processing executed by the poster creation application;

FIG. 10 is a diagram showing an example of a method for changing the size of a generated object;

FIG. 11 is a flowchart showing an example of replacement processing executed by the poster creation application; and

FIG. 12 is a diagram showing an example of an image pattern used during detection of a two-dimensional code.

### DESCRIPTION OF THE EMBODIMENTS

Hereinafter, preferred embodiments of the present disclosure will be described in detail with reference to the accompanying drawings. Note that the following embodiments are not intended to limit the present disclosure, and also, not all the combinations of features described in the embodiments below are necessarily essential as solutions provided by the present disclosure. Note that identical components are denoted by the same reference numerals.

There are services in which a user creates editing data such as a poster using an application, and prints an image generated based on the editing data. In such services, for example, original posters such as for store advertisements or events can be created and printed.

Further, in the above described application, a generated image of a poster or the like (poster image) can be output as digital data in a file format such as HTML format or JPEG (Joint Photographic Experts Group). By outputting the poster image as digital data in HTML format or the like, it can be displayed on a web page or the like.

In addition, for creating a poster image, a user can perform an editing operation such as placing a URL (Uniform Resource Locator) or a two-dimensional code on a canvas displayed by the above described application. This allows a person viewing the poster in which a URL or the like is embedded as an image to be guided to a web page containing more detailed information about the poster, or to an access destination indicated by information embedded in the two-dimensional code. In other words, a person viewing the poster reads the two-dimensional code using their smartphone or the like, so that the browser installed on the smartphone is launched, and the web page or the like indicated by the two-dimensional code is displayed on the browser.

While the application is capable of outputting the poster image to a recording medium or in a format such as HTML or JPEG format, the content of the image that the application should output may differ depending on these output formats.

For example, consider a case where a user uses the above described application to output a poster image in which a two-dimensional code is embedded as digital data in HTML format, to place the output digital data (image data) on a web page. In this case, a third party who uses a browser without a function to analyze two-dimensional codes can view the poster image on the web page using the browser. However, the third party cannot use such a browser to access the web page or the like indicated by the information embedded in the two-dimensional code of the poster image displayed on the web page.

On the other hand, in a case where a URL is embedded as text in the poster image instead of the two-dimensional code, even if using a browser without a two-dimensional code analysis function, the third party can input the URL into the input form of the browser. That is, in this case, since the third party can access the web page indicated by the URL embedded in the poster image through the browser, the situation where the third party cannot access a web page containing detailed descriptions as described above does not occur.

In order to prevent the situation described above, a technique is known in which a URL and a two-dimensional code are switched according to the output format and the functions of the terminal apparatus executing the above described application, to output a poster image embedded with either the URL or the two-dimensional code. However, even if such a technique is used to switch between a URL and a two-dimensional code to output a poster image, there is a possibility that the URL or the two-dimensional code may overlap with another object in the image. Therefore, the layout of the poster image may be disrupted so that an image different from the output result expected by the user may be output.

In the embodiments described below, a method will be described which appropriately modifies an object included in editing data according to an output format, while maintaining the layout of the image corresponding to the editing data.

### First Embodiment

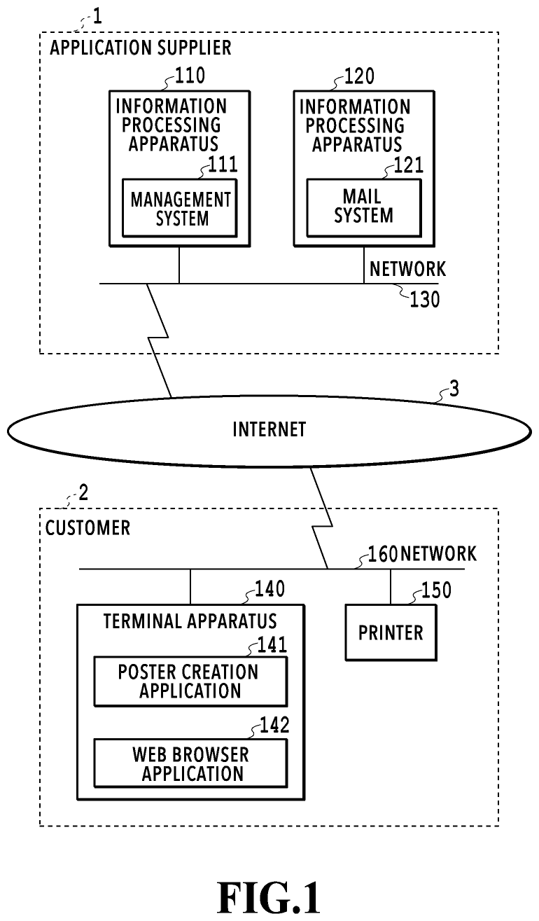

FIG. 1 is a diagram showing an example of the configuration of a poster creation and output system. As shown in FIG. 1, the system in the present embodiment includes information processing apparatuses 110 and 120 which are owned by an application supplier 1, and a terminal apparatus 140 and a printer 150 which are owned by a customer 2. These apparatuses are connected to each other via the Internet 3. The application supplier 1 provides a management system 111 and a mail system 121, which will be described later, to the customer 2. The customer 2 is a user who utilizes a poster creation application 141 and a web browser application 142, which will be described later (hereinafter, the customer 2 may be referred to as the user).

In the present embodiment, the information processing apparatuses 110 and 120 will be described as personal computers or servers by way of example. The terminal apparatus 140 is a type of information processing apparatus. In the present embodiment, the terminal apparatus 140 will be described as a personal information terminal such as a personal digital assistant (PDA) by way of example, but it is not limited thereto. For example, the terminal apparatus 140 may be a mobile phone, a smartphone, a personal computer, or a digital camera. That is, the terminal apparatus 140 may be of any type as long as it can execute the poster creation application 141 described later. The terminal apparatus 140 can connect to the Internet 3 via a mobile phone network, for example.

The poster creation application 141 is, for example, an application which is provided by the application supplier 1 and can generate a poster image by a user operation. Note that the poster creation application 141 may be a native application installed on the terminal apparatus 140, or a web application used via the web browser application 142.

Note that images that can be generated by the poster creation application 141 may be of any type, and are not limited to posters, as long as they can be generated by combining objects described later. Further, the poster creation application 141 can output editing data including multiple objects or read image data in different output formats.

The web browser application 142 (hereinafter sometimes abbreviated as web browser) is a general browser used for accessing the WWW (World Wide Web).

The printer 150 receives print data transmitted from the terminal apparatus 140, and prints an image based on the received print data. The print data received by the printer 150 includes print data for a poster image generated by the poster creation application 141 or the management system 111.

The print data includes, for example, a print ticket describing print settings or the like, a PDF (Portable Document Format) file as print image data, text information, and outline data. A network 160 is a home network for general household use owned by the customer 2 who uses the terminal apparatus 140. The network 130 is an office network owned by the application supplier 1.

The network 130 represents an office network at one location owned by the application supplier 1 as shown in FIG. 1, but is not limited to such a configuration. For example, the information processing apparatus 110 and the information processing apparatus 120 may be located at different locations, and an office network may be constructed at each location. In such a case, the office networks at different locations may be connected via the Internet.

The information processing apparatus 110 connected to the network 130 includes the management system 111. The information processing apparatus 110 transmits and receives data to and from the terminal apparatus 140 and the information processing apparatus 120 via the Internet 3.

The information processing apparatus 120 connected to the network 130 includes the mail system 121. The information processing apparatus 120 transmits and receives data to and from the information processing apparatus 110. Note that the management system 111 and the mail system 121 are realized by the information processing apparatus 110 and the information processing apparatus 120 executing corresponding programs, respectively.

The management system 111 provides content, information such as notification, print data, and so on to the poster creation application 141. However, the management system 111 is not limited to such a configuration. For example, the management system 111 may be realized by operation of a single information processing apparatus having the functions of the information processing apparatus 110 and the information processing apparatus 120. Alternatively, the function of the management system 111 may be implemented by a plurality of information processing apparatuses.

Further, the information processing apparatuses 110 and 120 are not necessarily required to be physical machines, and may be implemented in a serverless form. The information processing apparatus 120 may have a function other than that of the mail system 121. For example, the information processing apparatus 120 may distribute content to the poster creation application 141 or provide notification or the like.

In the present embodiment, the information processing apparatuses 110 and 120 have been described as being connected via the network 130 by way of example, but this is not limited thereto. For example, a case where the information processing apparatuses 110 and 120 are connected via the Internet 3 is also conceivable. The present embodiment can also be applied in such a case.

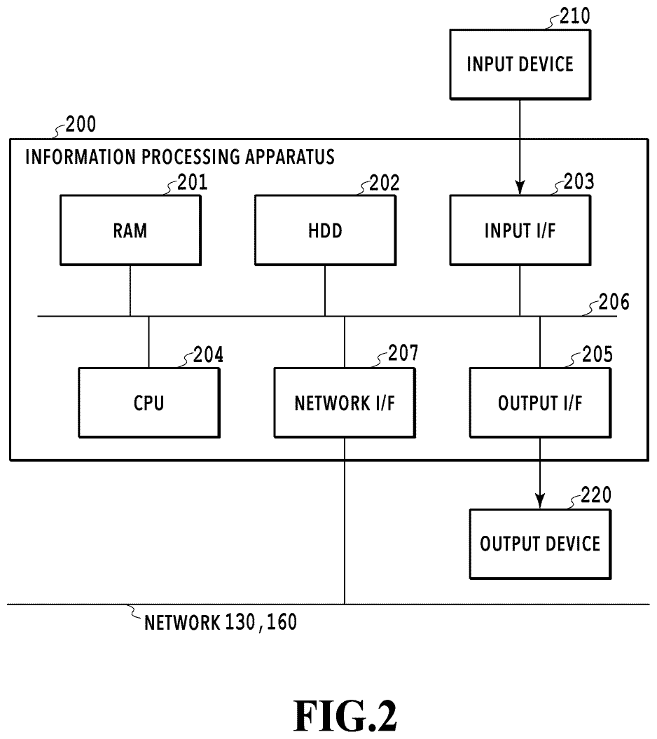

FIG. 2 is a diagram showing an example of the hardware configuration of an information processing apparatus 200. In the present embodiment, in a case where it is not necessary to distinguish between the terminal apparatus 140, the information processing apparatus 110, and the information processing apparatus 120, these are collectively referred to as the information processing apparatus 200.

The information processing apparatus 200 includes hardware as shown in FIG. 2. The information processing apparatus 200 includes a RAM 201 as a random access memory unit, an HDD 202 as a hard disk drive unit, an input interface (I/F) 203, a CPU 204, an output I/F 205, and a network I/F 207. These are interconnected by a system bus 206.

An input device 210 such as a keyboard or a mouse is connected to the input I/F 203. An output device 220, which is a display including a liquid crystal, an LED, or the like is connected to the output I/F 205. The network I/F 207 is connected to the network 130 or the network 160. The information processing apparatus 200 can communicate with other devices via the network I/F 207.

Note that in a case where the output device 220 has a touch panel function, the output device 220 is connected to an input/output I/F (not shown), so that the information processing apparatus 200 can detect a user operation on the output device 220 via the input/output I/F.

In the present embodiment, the input device 210 and the output device 220 are described as being connected externally to the information processing apparatus 200 by way of example, but this is not limited thereto. For example, the input device 210 and the output device 220 may be configured integrally with the information processing apparatus 200.

HDD 202 is a nonvolatile storing unit. Alternatively, an SSD (Solid State Drive), a portable CD-ROM, an internal ROM, or the like may be used as the storing unit.

The information processing apparatus 200 can receive a control signal or data input from the input device 210 via the input I/F 203. The information processing apparatus 200 can output a control signal, image data, or the like to the output device 220 via the output I/F 205.

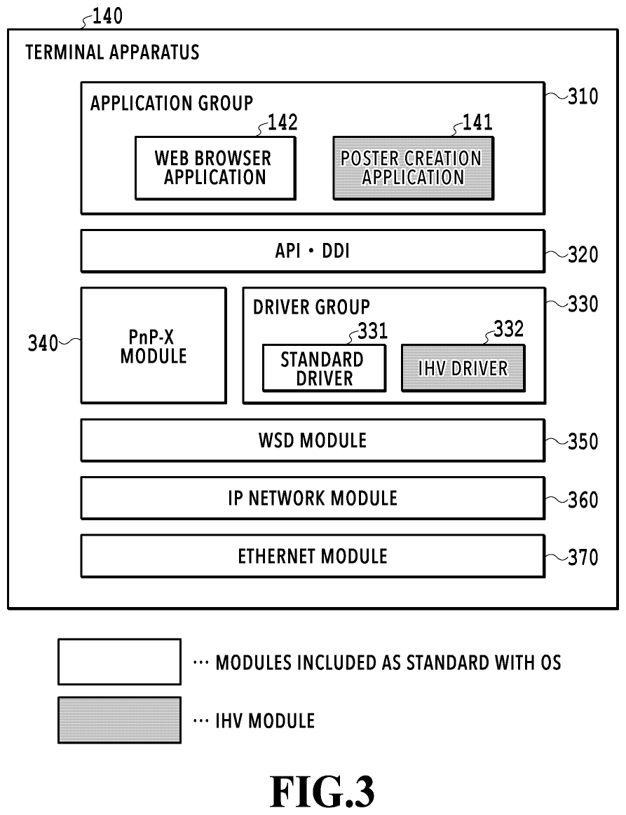

The CPU 204 is a control unit of the information processing apparatus 200, and controls the entire information processing apparatus 200. Each of modules (software) shown in FIG. 3, which will be described later, including the poster creation application 141, is stored, for example, in the HDD 202, read into the RAM 201 as needed, and executed by the CPU 204 of the terminal apparatus 140. Thereby, the CPU 204 realizes the functions of various applications (software).

The management system 111 shown in FIG. 1 is stored on, for example, the HDD 202 as a corresponding program, read into the RAM 201 as needed, and executed by the CPU 204 of the information processing apparatus 110. Thereby, the CPU 204 of the information processing apparatus 110 can realize the function of the management system 111.

FIG. 3 is a diagram showing an example of the software module configuration of the terminal apparatus 140. The terminal apparatus 140 has an application group 310, an API/DDI 320, a driver group 330, and a PnP-X module 340. The terminal apparatus 140 has a WSD (Web Service on Devices) module 350, an IP network module 360, and an Ethernet(R) module 370.

The application group 310 includes the web browser application 142 and the poster creation application 141. The application group 310 may also include applications other than the poster creation application 141 and the web browser application 142.

The driver group 330 includes a standard driver 331 and an IHV driver 332. The standard driver 331 is a driver included as standard with the OS. The IHV driver 332 is a driver manufactured by an IHV. The driver group 330 may also include drivers other than the standard driver 331 and the IHV driver 332.

The Ethernet(R) module 370 is a control stack that controls Ethernet(R). The IP network module 360 is a control stack that controls an IP network. The WSD module 350 is a control stack that controls WSD, which provides a mechanism for discovering devices on a network.

The PnP-X module 340 is a control stack that controls Plug and Play (PnP-X) on a network. Note that PnP-X is an abbreviation for “Plug and Play Extensions”. Specifically, PnP-X is a feature included as standard with the Windows® 10 OS as a set of extensions for Plug and Play and provides support for network-connected devices.

API/DDI320 is an interface including an API (Application Programming Interface) and a DDI (Device Driver Interface).

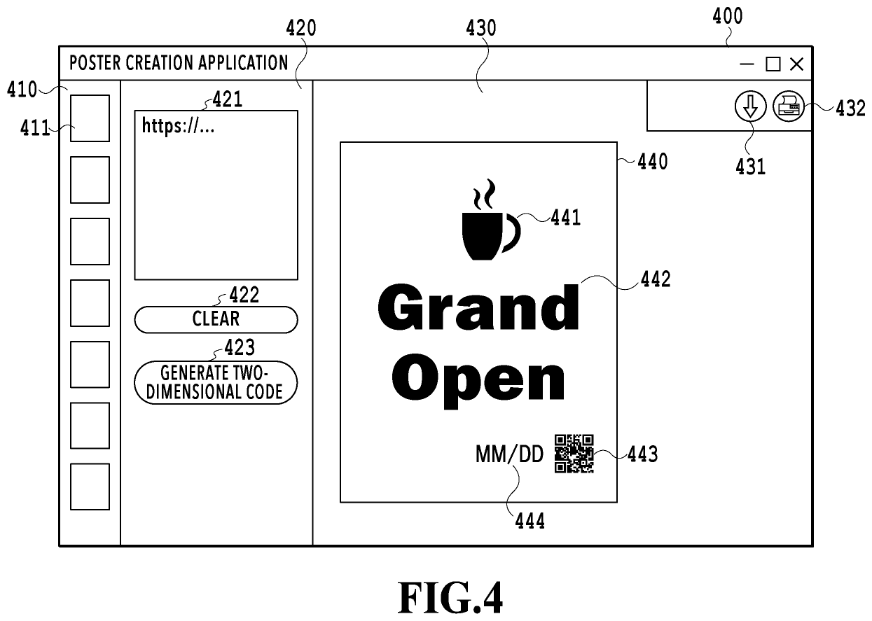

FIG. 4 is a diagram showing an example of the configuration of an editing screen 400 displayed by the poster creation application 141. The editing screen 400 has an operation selection area 410, a two-dimensional code generation area 420, and an editing data display area 430.

The operation selection area 410 displays a plurality of operation buttons including a button 411. By operating these buttons, a user can select various operations on editing data 440 described later. Operations in the present embodiment include editing operations such as adding an object to the editing data 440 and modifying an object included in the editing data 440. Modification of an object includes changing the size of an area occupied by the object (the display area of the object), changing the color of the object, and deleting the object. Examples of objects include an image, text, a shape, clip art, or a two-dimensional code. For example, a two-dimensional code may be a QR (Quick Response) code (R).

Further, the operations in the present embodiment are not limited to those described above. For example, the operations in the present embodiment may include adding a stamp or selecting a function in which the poster creation application 141 automatically changes the design of the editing data 440.

The two-dimensional code generation area 420 has an input unit 421, a clear button 422, and a generation button 423. The user inputs a character string such as a URL (Uniform Resource Locator) into the input unit 421, and presses the generation button 423. This causes the poster creation application 141 to generate as an object a two-dimensional code in which the input character string is embedded. However, this does not limit the configuration of the code to be generated, and in a case where the generation button 423 is pressed, another type of dimensional code such as a DataMatrix or MaxiCode may be generated.

If the clear button 422 is pressed by the user in a case where a character string has been entered in the input unit 421, this previously entered character string is deleted from the input unit 421 by the poster creation application 141. Then, the input unit 421 becomes blank. Note that a character string other than a URL may be entered into the input unit 421. For example, an email address, launch information for another application, or transition information may be entered into the input unit 421. That is, in addition to a URL, an email address, launch information for another application, or transition information such as a deep link may be embedded in the two-dimensional code object generated by the poster creation application 141.

The editing data 440 is displayed in the editing data display area 430. Here, the editing data 440 is displayed and managed in HTML format by the poster creation application 141.

In the present embodiment, the editing data 440 has been described by way of example as data of the layout of a poster being edited. The editing data 440 includes an object 441 representing clip art, objects 442 and 444 representing text, and an object 443 representing a two-dimensional code. Note that the objects included in the editing data 440 are not limited thereto. For example, instead of the object representing clip art, an object representing a photograph may be used, or an object representing a shape may be used. Further, the number of objects is not limited to four, and the editing data 440 may include three or less objects or five or more objects.

An object 443 is generated if the generation button 423 is pressed, based on any character string entered by the user in the input unit 421. Any object, including the object 443, can be placed at any location on the editing data 440.

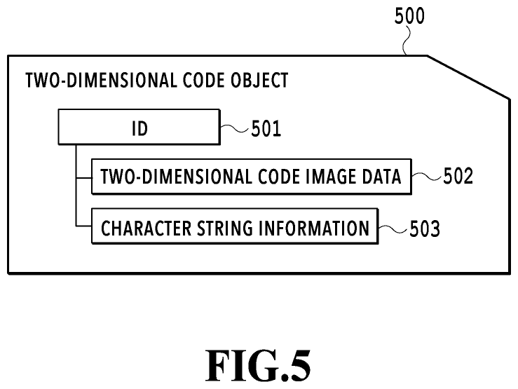

The configuration of an object representing a two-dimensional code including the object 443 generated by the poster creation application 141 (hereinafter sometimes referred to as a two-dimensional code object) will now be described. FIG. 5 is a diagram illustrating an example of the configuration of a two-dimensional code object. As shown in FIG. 5, a two-dimensional code object 500 has an ID 501 for uniquely identifying the object. The ID 501 is associated with two-dimensional code image data 502 and character string information 503.

Such information included in the two-dimensional code object 500 is registered in a database (not shown) held by the information processing apparatus 110. However, the method of storing the information included in the two-dimensional code object 500 is not limited thereto. For example, the information included in the two-dimensional code object 500 may be stored on a user's local PC, such as in a cookie or LocalStorage. Alternatively, the information included in the two-dimensional code object 500 may be stored on an on-premises PC, a server or database on a cloud, or a storage.

The method of managing information included in the two-dimensional code object 500 is not limited thereto. For example, the image data 502 of the two-dimensional code included in the two-dimensional code object 500 may be stored as an image file on a user's local PC, an on-premises PC, a server or database on a cloud, or a storage. Then, these storage locations for storing the two-dimensional code image data 502 may be registered in and managed by the database held by the information processing apparatus 110.

Returning to FIG. 4, the editing data display area 430 has a save button 431 and an output button 432. If the save button 431 is pressed by a user, the editing data 440 being edited is stored in a storing unit such as the HDD 202. The saved editing data 440 at this time is read by the poster creation application 141 on the same terminal, so that the user can perform an editing operation on the data from the point in time at which the editing data 440 was saved. Further, the saved editing data 440 may be read by the poster creation application 141 on another terminal.

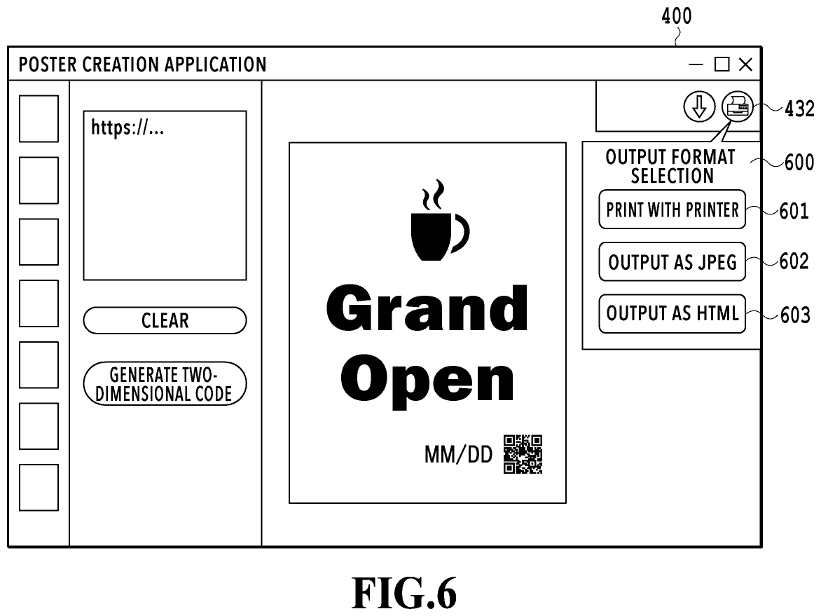

If the output button 432 is pressed by the user, a selection menu as shown in FIG. 6 is displayed as a pop-up. FIG. 6 is a diagram showing an example of the configuration of the editing screen 400 of the poster creation application 141, in a state where an output format selection menu 600 has been displayed, which is displayed if the output button 432 is pressed by the user.

The selection menu 600 is provided with a “Print with Printer” button 601, an “Output as JPEG” button 602, and an “Output as HTML” button 603. Each of these buttons accepts selection of the corresponding output format. However, these buttons do not limit the output formats, and may accept, for example, an instruction to output in PDF format or an instruction to output in another format.

Further, the display manner of these buttons is not limited to that shown in FIG. 6. For example, the “Output as JPEG” button 602 and the “Output as HTML” button 602 may be displayed if the save button 431 is pressed. Alternatively, the “Print with Printer” button 601, the “Output as JPEG” button 602, and the “Output as HTML” button 603 may be provided and displayed in the editing data display area 430, in a manner similar to the save button 431.

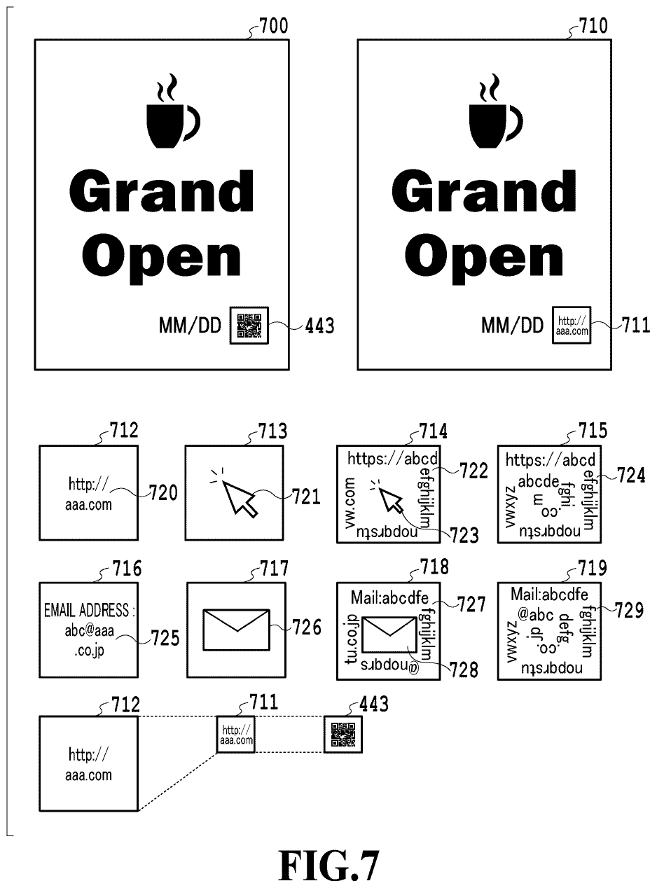

If the “Print with Printer” button 601 is pressed, the poster creation application 141 sends to the printer 150 print data generated by the management system 111 based on the editing data 440 being edited. Then, printing is executed by the printer 150 based on the received print data. In this case, the image of the two-dimensional code corresponding to the object 443 is printed as part of the poster 700 shown in FIG. 7. The poster creation application 141 has been described as a web application by way of example, but the generation of print data is not limited thereto.

For example, in a case where the poster creation application 141 is a native application, the poster creation application 141 can generate print data based on the editing data 440 being edited, and send the generated print data to the printer 150.

The printing process is described for a case where the poster creation application 141 is a native application and a case where it is a web application.

In the case where the poster creation application 141 is a native application installed and used on the terminal apparatus 140 or the like, a raster image is generated using a renderer provided in the poster creation application 141. The typical renderer specification specifies the drawing position and stacking order of each object as well as the vector data and image data forming the object. Then, by the poster creation application 141 passing the raster image to the standard driver 331 or the IHV driver 332, the poster 700 can be printed by the printer 150.

In the case where the poster creation application 141 is a web application, the poster creation application 141 generates the editing data 440 in HTML format. Then, the poster creation application 141 uses a screenshot function provided in the web browser application 142 to generate a raster image based on the data in HTML format. For example, in the data in HTML format, the <font> tag is used for text fonts, the <svg> tag is used for shapes, and the <img> tag is used for images.

A more detailed example of the process for generating a raster image by the screenshot function will be explained. The poster creation application 141 uses Puppeteer (https://pptr.dev/), which controls the web browser Chrome, to browse the data in HTML format in HEADLESS mode. Then, the poster creation application 141 can generate a raster image by specifying an image resolution or the like for the data in HTML format browsed using Puppeteer and then executing the screenshot function. Then, by the poster creation application 141 passing the raster image to the standard driver 331 or the IHV driver 332, the poster 700 can be printed by the printer 150.

If the “Output as JPEG” button 602 is pressed, the poster creation application 141 outputs the editing data 440 being edited to the HDD 202 as digital data in JPEG format. In this case, the image of the two-dimensional code corresponding to the object 443 is output as part of the poster 700 shown in FIG. 7 in JPEG format data.

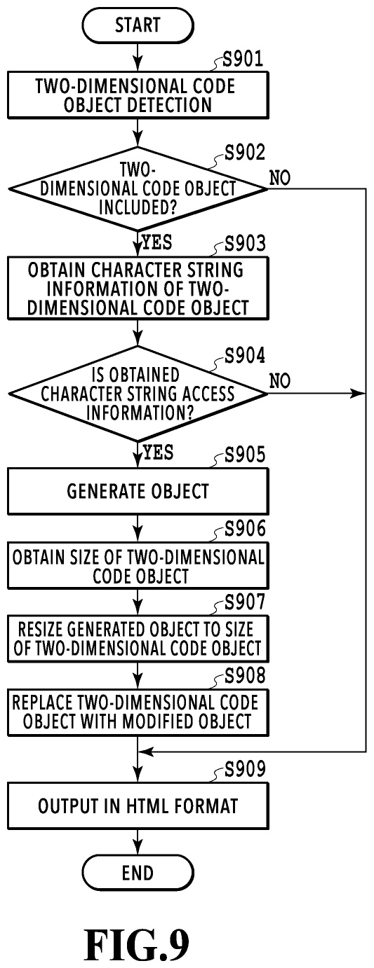

If the “Output as HTML” button 603 is pressed, the poster creation application 141 outputs the editing data 440 being edited to the HDD 202 as digital data in HTML format. In this case, after the processing shown in FIG. 9, which will be described later, for the object 443 representing the two-dimensional code is executed, the data is output in HTML format as in the example of the poster 710 shown in FIG. 7.

Note that the aforementioned digital data in JPEG format and in HTML format may be generated by the management system 111 or by the poster creation application 141.

FIG. 7 is a diagram showing an example of a poster as an output result based on the editing data 440. The editing data 440 being edited by the poster creation application 141 is output in a poster layout as shown in FIG. 7, according to an output format selected in the selection menu 600.

A poster 700 illustrates an example of the output result of the editing data 440. As described above, the editing data 440 is output as the poster 700 in response to the “Print with Printer” button 601 or the “Output as JPEG” button 602 being pressed.

The poster 710 is an output result of the editing data 440, but it differs from the poster 700 in that the image of the two-dimensional code corresponding to the object 443 is replaced with an object 711.

The object 711 is generated based on the character string information 503 of the object 443. Further, the object 711 in the poster 710 is positioned to fit within an area in which the image of the two-dimensional code corresponding to the object 443 arranged on the poster 700 is located.

The object 711 is an object in which reference information for a hyperlink is embedded (hereinafter sometimes referred to as a hyperlink object). It is assumed here that the character string information 503 held by the object 443, which is the source of the object 711, is a URL character string. In this case, a third party viewing on a web browser a page on which the poster 710 containing the object 711 is displayed can transit to a page indicated by the URL embedded in the object by pressing the object.

Further, it is assumed that the character string information 503 held by the object 443, which is the source of the object 711, is an email address starting with “mailto:”. In this case, if a third party viewing on a web browser a page on which the poster 710 containing the object 711 is displayed presses the object, a mailer of the third party is launched. Then, the launched mailer opens a mail input form addressed to the email address indicated by the character string information 503.

The objects 712 to 719 are variations of the object generated as the object 711. In the object 712, a URL character string 720 of a link destination is displayed. In the object 713, the icon 721 is displayed. The icon 721 is an image such as JPEG or png. However, this does not limit the configuration of the icon 721. A moving image such as a GIF (Graphics Interchange Format) may be used for the icon 721.

In the object 714, a URL character string 722 and an icon 723 are displayed. In the object 714, the link destination URL character string 722 is displayed in a manner that surrounds the icon 723. The icon 723 may be an image such as JPEG or png. Alternatively, a moving image such as a GIF may be used for the icon 723.

In the object 715, a link destination URL character string 724 is displayed in a spiral manner. In the object 716, an access destination mail address character string 725 is displayed. In this case, the email address character string 725 may be displayed by replacing the character string “mailto:” at the beginning of the character string information 503 with another character string such as “Email Address”. Alternatively, the email address character string 725 may be displayed as a character string indicating the email address with the character string “mailto:” removed.

In the object 717, an icon 726 is displayed. The icon 726 may be an image or use a moving image like the aforementioned icons. In the object 718, an access destination email address character string 727 and an icon 728 are displayed. In the object 718, the email address character string 727 is displayed in a manner that surrounds the icon 728. The icon 728 may be an image or use a moving image like the aforementioned icons. Further, the email address character string 727 may be displayed by replacing the character string “mailto:” at the beginning of the character string information 503 with another character string such as “Email Address”. The email address character string 727 may be displayed as a character string indicating the email address with the character string “mailto:” removed.

In the object 719, an access destination email address character string 729 is displayed in a spiral manner. In this case, the email address character string 729 may be displayed by replacing the character string “mailto:” at the beginning of the character string information 503 with another character string such as “Mail:”, or may be displayed as a character string indicating the email address with the character string “mailto:” removed.

However, the objects included in the poster 710 output as data in HTML format are not limited to the above described configurations. For example, as for the object 714, the URL character string 722 may be displayed at the top of the object 714 without surrounding the icon 723, and the icon 723 may be displayed at the bottom of the object 714. Further, the outer frames forming the outlines of the objects 711 to 719 need not necessarily be displayed.

Moreover, among the above described objects, the objects in which character strings are displayed need not necessarily display the URL or email address indicated by the character string information 503. For example, on the objects in which character strings are displayed, a character string representing “Grand Open!!” or a character string indicating a date and time may be displayed instead of the character string indicating the URL or email address. That is, the object 711 may be any design object that has accessibility to detailed information about the content shown on the poster. Accessibility in the present embodiment refers to the property indicating to a user that access to predetermined information is possible. In other words, as long as the object 711 has a design with accessibility, the manner of its display is not limited. In addition, any character string, image, or moving image may be displayed in the object 711.

Alternatively, even if the “Output as HTML” button 603 is pressed, the poster creation application 141 may output data in HTML format in the same manner as the poster 700 without replacing the two-dimensional code object with an object as described above.

As one example, the poster creation application 141 may attach reference information for a hyperlink to the object 443 based on the character string information 503 of the object 443, and then output data in HTML format in the same manner as the poster 700.

Further, in the area of the object after the replacement processing shown in FIG. 9, which is included in the output data in HTML format, a character string, an image, or the like as the object described above need not necessarily be displayed. In addition, in the area of the object after the replacement processing, a character string, an image, or the like may not be displayed while the outer frame of the object may be displayed.

In addition, the shape of the object after the replacement processing is not limited to a rectangular shape, and may be circular or triangular. That is, as long as the shape of the object after the replacement processing falls within the scope of the processing and is a shape having accessibility or a shape indicating to a user that the object can be pressed, the shape of the object may be any shape.

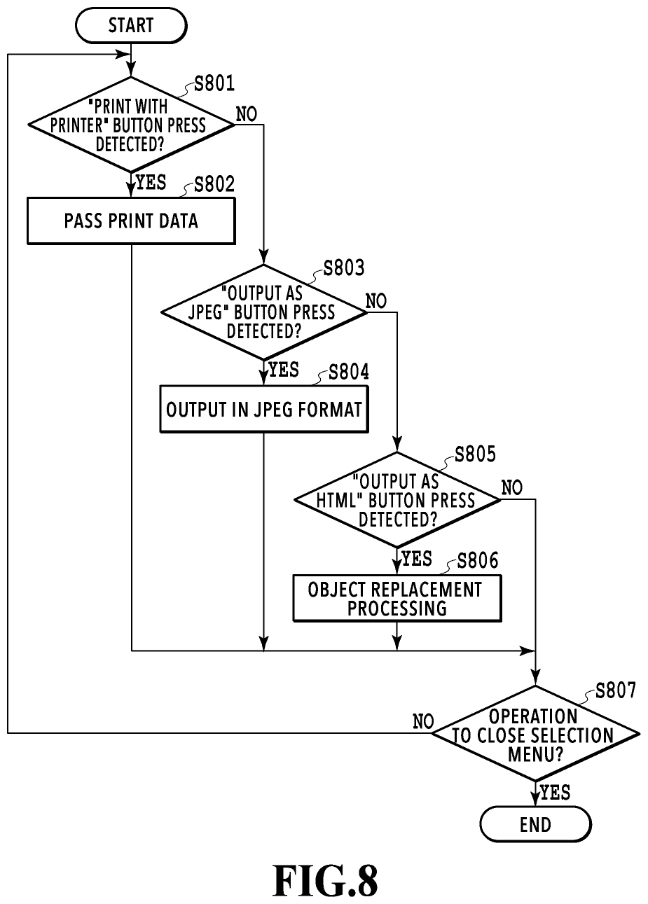

Next, with reference to FIGS. 8 to 10, processing executed by the CPU 204 of the terminal apparatus 140 in the present embodiment as a function of the poster creation application 141 will be described.

FIG. 8 is a flowchart showing an example of processing executed by the CPU 204 of the terminal apparatus 140 as a function of the poster creation application 141. The processing shown in FIG. 8 is realized by the CPU 204 of the terminal apparatus 140 reading a program stored in the HDD 202 into the RAM 201 and executing it. Note that some or all of the functions in the steps of FIG. 8 may be implemented using hardware such as an ASIC or electronic circuit. The symbol “S” in the description of each process means a step in the flowchart (Hereinafter, the same applies to flowcharts in this specification). The process shown in FIG. 8 starts if the poster creation application 141 detects a pressing operation on the output button 432 provided on the editing screen 400. In this case, the selection menu 600 is displayed in response to the output button 432 being pressed.

In S801, the CPU 204 determines whether a press on the “Print with Printer” button 601 provided in the selection menu 600 has been detected by the poster creation application 141. If the CPU 204 determines in S801 that a press on the “Print with Printer” button 601 has been detected (Yes) by the poster creation application 141, it proceeds to S802. If the CPU 204 determines in S801 that no press on the “Print with Printer” button 601 has been detected (No) by the poster creation application 141, it proceeds to S803.

In S802, the CPU 204 passes print data corresponding to the editing data 440 being edited on the editing screen 400 to the standard driver 331 or the IHV driver 332 by the poster creation application 141, and then proceeds to S807. The standard driver 331 or the IHV driver 332 sends the received print data to the printer 150. Then, the printer 150 prints an image based on the received print data.

In S803, the CPU 204 determines whether a press on the “Output as JPEG” button 602 provided in the selection menu 600 has been detected by the poster creation application 141. If the CPU 204 determines in S803 that a press on the “Output as JPEG” button 602 has been detected (Yes) by the poster creation application 141, it proceeds to S804. If the CPU 204 determines in S803 that no press on the “Output as JPEG” button 602 has been detected (No) by the poster creation application 141, it proceeds to S805.

In S804, the CPU 204 outputs in JPEG format the editing data 440 being edited on the editing screen 400 by the poster creation application 141, and then proceeds to S807. The output method is as described above, so the description thereof will be omitted.

In S805, the CPU 204 determines whether a press on the “Output as HTML” button 603 provided in the selection menu 600 has been detected by the poster creation application 141. If the CPU 204 determines in S805 that a press on the “Output as HTML” button 603 has been detected (Yes) by the poster creation application 141, it proceeds to S806. If the CPU 204 determines in S805 that no press on the “Output as HTML” button 603 has been detected (No) by the poster creation application 141, it proceeds to S807.

In S806, the CPU 204 executes object replacement processing described later by the poster creation application 141, and then proceeds to S807. That is, the poster creation application 141 does not execute the object replacement processing in a case where a button other than the “Output as HTML” button 603 is selected among buttons displayed in the selection menu 600, that is, in a case where an output format other than HTML format is accepted.

In S807, the CPU 204 determines whether an operation to close the displayed selection menu 600 has been detected by the poster creation application 141. The operation to close the selection menu 600 is, for example, a user operation on the editing screen 400 outside the display area of the selection menu 600. If the CPU 204 determines in S807 that an operation to close the selection menu 600 has been detected (Yes) by the poster creation application 141, it terminates this flow and closes the selection menu 600. If the CPU 204 determines in S807 that an operation to close the selection menu 600 has not been detected (No) by the poster creation application 141, it returns to S801. In this way, the poster creation application 141 repeats this flow until it detects an operation to close the selection menu 600.

FIG. 9 is a flowchart showing an example of object replacement processing shown in S806 of FIG. 8, which is processing executed by the CPU 204 as a function of the poster creation application 141. The process shown in FIG. 9 starts if the poster creation application 141 detects a press on the “Output as HTML” button 603.

In S901, the CPU 204 performs detection of a two-dimensional code object from objects included in the editing data 440 being edited by the poster creation application 141, and proceeds to S902. At this time, the number of two-dimensional code objects included in the editing data 440 may be zero, one, or more.

In S902, the CPU 204 determines whether a two-dimensional code object is included in the editing data 440 or not based on the detection result in S901 by the poster creation application 141. If the CPU 204 determines in S902 that a two-dimensional code object is included in the editing data 440 (Yes) by the poster creation application 141, it proceeds to S903. If the CPU 204 determines in S902 that no two-dimensional code object is included in the editing data 440 (No) by the poster creation application 141, it proceeds to S909.

Therefore, if it is determined in S902 that no two-dimensional code object is included in the editing data 440 (No), the poster creation application 141 does not execute the processing from S903 to S908. Specifically, in such a case, the poster creation application 141 does not generate an object in S905, and does not perform the object replacement processing in S908.

In S903, the CPU 204 obtains character string information of the two-dimensional code object by the poster creation application 141, and proceeds to S904. Specifically, the poster creation application 141 obtains the character string information 503 as shown in FIG. 5 from the two-dimensional code object detected in S901.

In S904, the CPU 204 determines whether the character string information obtained in S903 is access information by the poster creation application 141. Access information in the present embodiment refers to information indicating a URL, an email address, or the like. For example, the CPU 204 determines whether the character string information 503 is a character string starting with “http://”, “https://”, or “mailto:” in half-width alphanumeric characters by the poster creation application 141.

If the character string information 503 is such a character string, that is, if the CPU 204 determines in S904 that the character string information obtained in S903 is access information (Yes) by the poster creation application 141, it proceeds to S905. If the CPU 204 determines in S904 that the character string information obtained in S903 is not access information (No) by the poster creation application 141, it proceeds to S909.

Accordingly, if the character string information obtained in S904 is not access information, that is, if access information is not embedded in the two-dimensional code object included in the editing data, the poster creation application 141 does not execute the processing from S905 to S908. Specifically, in such a case, the poster creation application 141 does not generate an object in S905, and does not perform the object replacement processing in S908.

In S905, the CPU 204 generates an object based on the character string information 503 determined in S904 to be access information by the poster creation application 141, and proceeds to S906. Specifically, in S905, the poster creation application 141 generates a hyperlink object. Examples of the hyperlink object generated in S905 include the object 712 to the object 719 as shown in FIG. 7.

In S906, the CPU 204 obtains size information for the two-dimensional code object included in the editing data 440 by the poster creation application 141, and proceeds to S907. The size information for the two-dimensional code object is information indicating, for example, the height and width of the area occupied by the two-dimensional code object detected in S901.

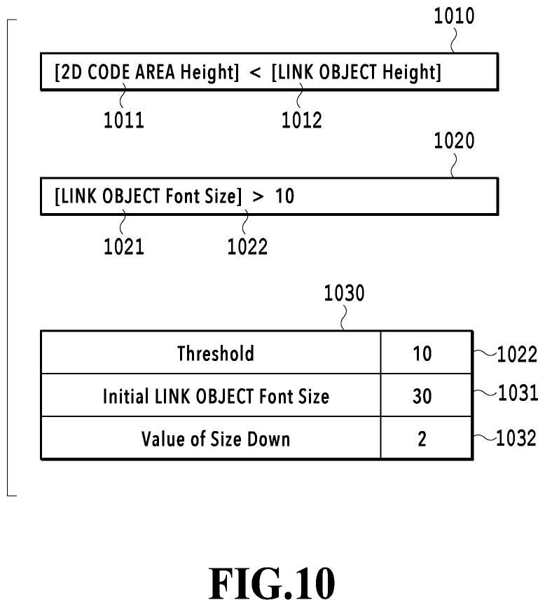

In S907, the CPU 204 changes the size of the area occupied by the object generated in S905 such that it fits within the size of the area occupied by the two-dimensional code object obtained in S906 by the poster creation application 141. In this case, the poster creation application 141 can change the size of the area occupied by the object generated in S905 using a method illustrated in FIG. 10.

FIG. 10 is a diagram showing an example of a method for changing the size of the area occupied by the object generated in S905 such that it fits within the size of the area occupied by the two-dimensional code object obtained in S906. FIG. 10 shows an expression 1010, an expression 1020, and a table 1030.

The expression 1010 is an expression for comparing the height 1011 of the two-dimensional code object obtained in S906 with the height of the object generated in S905. The poster creation application 141 uses the expression 1010 to compare the height 1011 of the two-dimensional code object obtained in S906 with the height information 1012 of the object generated in S905. Then, the poster creation application 141 repeats the process until the height information 1012 of the object generated in S905 becomes smaller than the height 1011 of the two-dimensional code object obtained in S906.

Note that the processing for changing the size of the area occupied by the object generated in S905 is not limited thereto. For example, the poster creation application 141 may change the height of the object generated in S905 in accordance with the height indicated by the size information of the two-dimensional code object obtained in S906.

Further, the poster creation application 141 may also change the width of the object generated in S905 using a similar method to that described above for changing the height of an object.

In this case, the poster creation application 141 changes a font size 1021 used for an object to be resized (hereinafter referred to as the font size of an object) each time the aforementioned size changing processing using the expression 1010 is repeated. For example, each time the aforementioned size changing processing is repeated, the poster creation application 141 decrements the value set as an initial value 1031 of the font size of the object generated in S905, by the value set as a size down value 1032.

Specifically, each time the aforementioned size changing processing is repeated, the poster creation application 141 decrements “30”, which is set as the initial value 1031 of the font size, by “2”, which is set as the size down value 1032.

The expression 1020 is an expression for comparing the font size 1021 of an object to be resized with a threshold 1022. The poster creation application 141 uses the expression 1020 to compare the font size 1021 of the object to be resized with the threshold 1022. Then, the poster creation application 141 continues to reduce the font size 1021 of the object to be resized until it becomes smaller than the threshold 1022.

Note that the processing for changing the font size of the object to be resized is not limited thereto. For example, the poster creation application 141 may change the font size of the object to be resized in accordance with the value set as the threshold 1022.

If an object satisfying the predetermined conditions is obtained as a result of executing the aforementioned size changing processing and the aforementioned font size changing processing, the CPU 204 proceeds to S908 by the poster creation application 141. An object satisfying the predetermined conditions is, for example, an object whose height 1012 is smaller than the value 1011 indicating the height of the two-dimensional code object, and whose font size 1021 is smaller than the threshold 1022.

However, the expressions and values used in the size changing processing and font size changing processing are not limited to these. For example, the threshold 1022, the initial font size value 1031, and the size down value 1032 can be set to any natural number. Further, the initial font size value 1031 is not limited to 30, and may be any value greater than the threshold 1022. Further, the size down value 1032 is not limited to 2, and may be any value smaller than the initial font size value 1031.

Further, the threshold 1022 may be a variable. For example, the threshold 1022 may be a magnification ratio of the size of the area occupied by the two-dimensional code object indicated by the size information obtained in S906, relative to the size of the area of the object generated in step S905. In this case, the poster creation application 141 can change the font size of the object to be resized to a font size indicated by a value obtained by multiplying the initial font size value 1031 by the aforementioned magnification ratio.

In S908, the CPU 204 replaces the two-dimensional code object detected in S901 with the object obtained in S907 by the poster creation application 141, and then proceeds to S909. Specifically, in S908, the poster creation application 141 replaces the two-dimensional code object detected in S901 with the object obtained in S907 such that it fits within the size of the area in which the two-dimensional code object arranged on the layout of the editing data is located.

Note that in a case where a plurality of two-dimensional code objects are detected in S901, an object corresponding to each detected two-dimensional code object is generated in S905. Then, through S906 and S907, the poster creation application 141 performs the replacement processing for each two-dimensional code object.

In S909, the CPU 204 collects data necessary for output in HTML format and outputs the editing data 440 as digital data in HTML format to the HDD 202 by the poster creation application 141, and terminates this flow. For example, if proceeding via S902 (No) or S904 (No), then in S909, the CPU 204 outputs the editing data 440 in HTML format without replacing the two-dimensional code object by the poster creation application 141. If proceeding via S908, then in S909, the CPU 204 outputs the editing data in HTML format by the poster creation application 141, in which the two-dimensional code object detected in S901 has been replaced with the object obtained in S907.

Note that regarding the output flow in S909, its description is omitted since it is similar to a general data output process. However, the output destination is not limited to the HDD 202, and may be an external storage connected to the terminal apparatus 140 or a cloud.

Although the flow of the processing executed by the poster creation application 141 upon detecting a press on the “Output as HTML” button 603 has been described, it is not limited to the flow shown in FIG. 9. For example, the processing for obtaining character string information (S903) and the processing for obtaining size information of the two-dimensional code object (S906) may be executed in parallel, or S906 may be executed before S903.

Further, prior to the processing for replacing the two-dimensional code object with the object obtained in S907, the poster creation application 141 may display a confirmation screen (not shown) to ask the user whether to modify the two-dimensional code object. Further, the poster creation application 141 may be configured to allow the user to preset whether or not to execute the two-dimensional code object replacement processing through an optional screen (not shown) accessible from the editing screen 400. For example, if a setting has been made to permit execution of the two-dimensional code object replacement processing, the poster creation application 141 executes the flow shown in FIG. 9. If a setting has been made to prohibit execution of the two-dimensional code object replacement processing, the poster creation application 141 outputs the editing data 440 in HTML format without executing the flow shown in FIG. 9.

According to the present embodiment, an object included in editing data can be appropriately modified according to an output format, while maintaining the layout of the image based on the editing data. Further, in a case where the editing data is output in a specific output format such as HTML format, changing the two-dimensional code object included in the editing data to an object having a design with accessibility enables appropriate guidance to the access destination.

### Second Embodiment

In the above described embodiment, processing for outputting editing data generated by the poster creation application 141 has been described. However, it is also conceivable that the poster creation application 141 reads image data, not limited to editing data edited by the user via the editing screen 400, and outputs that image data according to the output format.

The present embodiment describes a case where the poster creation application 141 reads image data in formats such as JPEG or PDF and outputs that image data according to the output format.

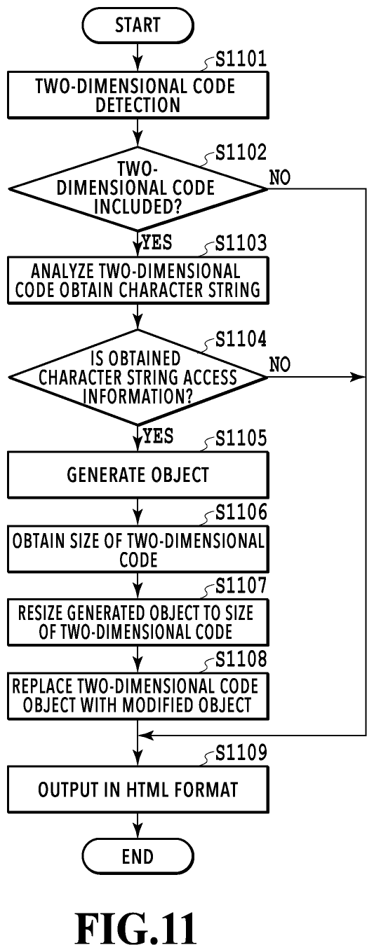

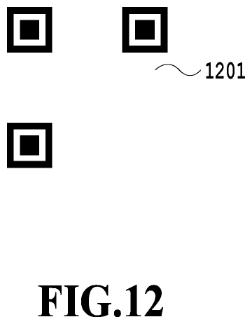

The basic configuration of the information processing apparatus 200 in the present embodiment is the same as in the above described embodiment, so the description thereof will be omitted. The two-dimensional code in the present embodiment differs from the above described embodiment in that it is embedded in the image data read by the poster creation application 141, rather than in an object. Further, the two-dimensional code embedded in the image data read by the poster creation application 141 does not have the character string information 503 as shown in FIG. 5. Referring to FIGS. 11 and 12, processing performed by the poster creation application 141 in the present embodiment will be described. Note that the two-dimensional code in the present embodiment and the two-dimensional code object in the above described embodiment may collectively be referred to as a two-dimensional code image.

FIG. 11 is a flowchart showing an example of processing executed by the CPU 204 of the terminal apparatus 140 as a function of the poster creation application 141 in the present embodiment. The process shown in FIG. 11 is started in response to detecting a user operation targeting image data for output after reading the image data by the poster creation application 141. For example, the process shown in FIG. 11 is started in response to detecting a press on the “Output as HTML” button 603 after reading the image data by the poster creation application 141.

However, data that the poster creation application 141 can read is not limited to data in formats such as JPEG or PDF. For example, data that can be read by the poster creation application 141 may be an image file such as PNG, a document file such as docx format, a spreadsheet file such as xlsx format, a presentation file such as pptx format, or the like.

S1102 and S1105 to S1109 shown in FIG. 11 are equivalent to S902 and S905 to S909 in the above described embodiment, so their descriptions will be omitted. In other words, compared to the above described embodiment, the processing for detecting a two-dimensional code (S1101), the processing for analyzing the two-dimensional code to obtain a character string (S1103), and the processing for determining whether or not the obtained character string is a URL or the like (S1104) are different. Referring to FIG. 11, the processing differing from the aforementioned embodiment will be described.

In S1101, the CPU 204 performs detection of a portion in the read image data that is similar to a specific image pattern, by the poster creation application 141, and then proceeds to S1102. The specific image pattern is, for example, an image pattern such as that shown in FIG. 12. FIG. 12 is a diagram showing an example of the specific image pattern in the present embodiment. An image pattern 1201 is an example of an image pattern used by the poster creation application 141 to detect a two-dimensional code in S1101.

However, in the detection of the two-dimensional code in the present embodiment, the image pattern included in the image data need not necessarily match the image pattern 1201 shown in FIG. 12. For example, if there is a portion within the image data read by the poster creation application 141 that is at least partially similar to the image pattern 1201, it may be determined in S1102 that a two-dimensional code is included in the image data. In determining whether a portion is similar to the image pattern 1201, the determination may be performed by applying the image pattern to the read image data from any direction including vertical, horizontal, or diagonal directions.

In S1103, the CPU 204 analyzes the image of the two-dimensional code detected in S1101 and obtains the character string embedded in the two-dimensional code by the poster creation application 141, and then proceeds to S1104. In this case, the analysis of the two-dimensional code can be achieved using a function that is natively provided in the browser, such as a Barcode Detection API. However, the analysis of the two-dimensional code image in the present embodiment is not limited to methods using a function such as the Barcode Detection API, and may use analysis libraries or proprietary analysis algorithms.

In S1104, the CPU 204 determines whether the character string obtained in S1103 is access information by the poster creation application 141. If the CPU 204 determines in S1104 that the character string obtained in S1103 is access information (Yes) by the poster creation application 141, it proceeds to S1105. If the CPU 204 determines in S1104 that the character string obtained in S1103 is not access information (No) by the poster creation application 141, it proceeds to S1109.

Note that if the read image data is erroneously determined to contain a specific image pattern and the character string cannot be obtained in S1103, the CPU 204 proceeds to S1109 by the poster creation application 141.

According to the present embodiment, even in a case where the poster creation application reads image data in a format such as JPEG or PDF and outputs the image data according to the output format, the same effect as the above described embodiment can be achieved.

Note that the image data output method in the present embodiment is not limited to the above described method. For example, the read JPEG or PDF format image data may be further edited by the poster creation application, and the edited data may be output. Further, in a case where multiple two-dimensional codes are included in image data, the number of two-dimensional codes included in the image data is not limited, as long as each of the multiple two-dimensional codes can be recognized by a two-dimensional code reader.

### Other Embodiments

Although the embodiments have been described in detail above, the present disclosure is not limited to any particular embodiment, and various modifications and changes can be made within the scope of the present disclosure. For example, embodiments may take the form of system, an apparatus, a method, a program, or a storage medium. Specifically, the present disclosure may be applied to a system including multiple devices or applications, or to an apparatus including a single device or application. The terminal apparatus for creating a poster need not necessarily have a printer connected, and printing the created poster may be outsourced to a printing company or the like. Further, while conversion of a two-dimensional code is performed, this does not limit the configuration, and any two-dimensional code, for example, DataMatrix or MaxiCode may be supported. Although in the first and second embodiments, the two-dimensional code is automatically replaced with a link object, it is also possible to prompt a user for confirmation before replacement, or to allow a setting such as an option to enable or disable replacement beforehand.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Further, the functions of the above described embodiments are realized not only by a computer executing the read program code, but also by an OS or the like running on the computer performing part or all of the actual processing based on instructions of the program code. It goes without saying that the case where the functions of the above described embodiments are realized by such processing is also included.

Further, the program code read from the storage medium is written into a memory provided on a function expansion board inserted into the computer or on a function expansion unit connected to the computer. Thereafter, based on instructions of the program code, a CPU or the like provided on the function expansion board or the function expansion unit performs part or all of the actual processing, and it goes without saying that the case where the functions of the above described embodiments are realized by such processing is also included.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-209787, filed Dec. 2, 2024, which is hereby incorporated by reference herein in its entirety.

What is claimed is:

1. A non-transitory computer-readable storage medium storing a program of an application for causing an information processing apparatus to execute a method, the method comprising:
accepting a selection of one of a plurality of output formats for outputting data of a layout obtained by the application, the plurality of output formats including an output in HTML (HyperText Markup Language) format;
in a case where a two-dimensional code image indicating two-dimensional code is included in the data, generating an object in which predetermined reference information is embedded, in response to the output in the HTML format being selected in the accepting, such that the object fits within a size of an area in which the two-dimensional code image arranged on the layout is located;
replacing the two-dimensional code image with the object in the layout; and
controlling so as to output, in the HTML format, the data representing the layout in which the two-dimensional code image has been replaced with the object by the replacing.

2. The storage medium according to claim 1, wherein the data is editing data generated by the application through a user's editing operation or image data read by the application.

3. The storage medium according to claim 1, wherein a character string indicating either a URL (Uniform Resource Locator) or an email address is embedded in the two-dimensional code image.

4. The storage medium according to claim 3, wherein the predetermined reference information is information for referencing either the URL or the email address indicated by the character string.

5. The storage medium according to claim 4, wherein the predetermined reference information is information for a hyperlink.

6. The storage medium according to claim 3, wherein the character string embedded in the two-dimensional code image, an icon, or a combination thereof is displayed on the object.

7. The storage medium according to claim 3, wherein in a case where the two-dimensional code image is not included in the data or in a case where the character string is not embedded in the two-dimensional code image, the generating does not generate the object.

8. The storage medium according to claim 3, wherein in a case where the two-dimensional code image is not included in the data or in a case where the character string is not embedded in the two-dimensional code image, the controlling performs control so as to output, in the HTML format, the data in a state where the two-dimensional code image has not been replaced with the object by the replacing.

9. The storage medium according to claim 1, wherein generation of the object by the generating comprises: a size changing process of changing the size of an area occupied by the object such that it fits within the size of the area occupied by the two-dimensional code image arranged on the layout; and a font size changing process of changing a font size used in the object based on a preset threshold.

10. The storage medium according to claim 1, wherein in a case where the accepting accepts an output format other than the HTML format among the plurality of output formats, the controlling is not performed.

11. The storage medium according to claim 1, wherein the application is a native application installed and used on the information processing apparatus, or a web application used via a web browser.

12. The storage medium according to claim 1, wherein the two-dimensional code image is an image representing a QR (Quick Response) code.

13. An information processing apparatus that executes an application, the apparatus comprising:
at least one memory and at least one processor which function as:
an accepting unit configured to accept a selection of one of a plurality of output formats for outputting data of a layout obtained by the application, the plurality of output formats including an output in HTML format;
a generating unit configured to, in a case where a two-dimensional code image indicating two-dimensional code is included in the data, generate an object in which predetermined reference information is embedded, in response to the output in the HTML format being selected in the accepting unit, such that the object fits within a size of an area in which the two-dimensional code image arranged on the layout is located;
a replacing unit configured to replace the two-dimensional code image with the object in the layout; and
a controlling unit configured to control so as to output, in the HTML format, the data representing the layout in which the two-dimensional code image has been replaced with the object by the replacing unit.

14. A control method for an information processing apparatus that executes an application, the method comprising:
accepting a selection of one of a plurality of output formats for outputting data of a layout obtained by the application, the plurality of output formats including an output in HTML format;
in a case where a two-dimensional code image indicating two-dimensional code is included in the data, generating an object in which predetermined reference information is embedded, in response to the output in HTML format being selected in the accepting, such that the object fits within a size of an area in which the two-dimensional code arranged on the layout is located;
replacing the two-dimensional code image with the object in the layout; and
controlling so as to output, in the HTML format, the data representing the layout in which the two-dimensional code image has been replaced with the object by the replacing.
